(19) United States
(12) Patent Application Publication
(10) Pub. No.: US 2007/0160320 A1
(43) Pub. Date: Jul. 12, 2007

(54) Merchandising systems, methods of mechandising, and point-of-sale devices comprising micro-optics technology

(75) Inventors: Kenneth Stephen McGuire, Cincinnati, OH (US); Charles John Berg, Wyoming, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/650,284

(22) Filed: Jan. 5, 2007

Related U.S. Application Data
(60) Provisional application No. 60/756,733, filed on Jan. 6, 2006.

(51) Int. Cl. G02B 6/26

(52) U.S. Cl. 385/15

(57) ABSTRACT

A merchandising system, comprising: a consumer product. The merchandising system comprises at least one of the consumer product, packaging for the consumer product, and advertisement material pertaining to the consumer product. At least one merchandising system elements comprises indicia and/or an image that relates, or is analogous to, an attribute and/or targeted benefit of the consumer product. At least one merchandising system elements comprises a micro-optic structure capable of controlling the scatter of light impinging thereon so that the micro-optic structure reflects and/or transmits light in a field of view over which at least a portion of the indicia and/or image appears brighter relative to that outside the field of view.

### CROSS REFERENCE TO RELATED APPLICATIONS

This application claims the benefit of under 35 USC §119(e) to U.S. Provisional patent application Ser. No. 60/756,733, filed Jan. 6, 2006, which application is hereby incorporated herein by reference.

### FIELD OF THE INVENTION

The present invention relates to merchandising systems, methods of merchandising products, and point-of-sale devices that employ micro-optics technology to feature indicia and/or an image associated with a product.

### BACKGROUND OF THE INVENTION

Prospective buyers can face an overwhelming number of options when shopping for a specific consumer product. For example, the number of different beauty care products being offered for sale in a retail establishment can reach into the hundreds. Manufacturers of consumer products typically include claims on their goods, both to provide information to consumers, and to distinguish their goods from competing goods. Thus, prospective buyers must attempt to digest a significant amount of textual information associated with the different products and compare the same. The length of time required to thoroughly accomplish this task may be unworkable for many consumers. Furthermore, many consumers may find it easier to relate to pictures, illustrations, indicia, or other visual representations rather than simply text to understand important aspects (e.g., an attribute and/or targeted benefit) of a specific product, as noted by the oft-cited phrase “a picture is worth a thousand words.”

Manufacturers of products also generally include various color and graphic schemes to distinguish their goods from competing goods. Due to the large number of competing products however, the collection of different colors and graphics may tend to blend together in the eyes of a prospective buyer looking at the shelves containing the plethora of different products. The color and graphic schemes accordingly may contribute little to distinguishing competing goods. Moreover, the various colors and graphics do not necessarily provide important information about the product for an initial purchase decision or for allowing consumers to compare competing products.

Accordingly, there is a need for a visual methodology that can help consumers distinguish a product from competing products and/or communicate visual imagery relating to a product's attributes and/or targeted usefulness.

### BRIEF DESCRIPTION OF THE DRAWINGS

While the specification concludes with claims particularly pointing out and distinctly claiming the subject matter which is regarded as forming the present invention, it is believed that illustrative embodiments of the present invention may be better understood from the following description taken in conjunction with the accompanying drawings, in which:

FIG. 1 is a perspective view of an exemplary point-of-sale device suitable for use with the present invention;

FIG. 2 is a perspective view of an exemplary primary packaging container suitable for employment with the present invention; and

FIG. 3 is a perspective view of an exemplary secondary packaging container suitable for receiving the primary packaging container shown in FIG. 2 and for employment with the present invention.

### DETAILED DESCRIPTION OF THE INVENTION

It is to be understood that the scope of the claims is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural.

As used herein, “consumer product” includes consumable goods that get used up and have to be replaced; personal use devices, implements, appliances that may or may not employ consumable components; and architectural surface coverings.

As used herein, “indicia” means an identifying mark, including text and/or graphics.

As used herein, “image” means a photograph, illustration and/or other pictorial representation of a mammal or object.

As used herein, “micro-optic” and “micro-optic technology” refers to a structure comprising one or more optical elements that are typically dimensioned on the order of tens of microns or less; although optical elements that are larger than this can also be employed. The optical elements generally manipulate light so as to provide various visual effects by themselves or visual effects upon accompanying indicia and/or images. These terms include, but are not limited to, structures that are disclosed in U.S. Pat. Nos. 5,359,454; 5,461,495; 5,475,533; 5,503,902; 5,568,313; 5,715,316; 6,288,842; and 6,870,681, and U.S. Published Patent Application Nos. 2003/0179364; 2003/0232179; 2004/0042753; 2004/0067360; and 2005/0180020.

As used herein, “packaging” means a structure or material that is at least partially disposed on or about a consumer product when the product is presented to the public. “Primary packaging” means any container, including its closure, pump, cap or other peripheral items, in which the consumer product is in direct contact. And “secondary packaging” means any additional materials that are associated with the primary packaging, such as, for example, a container such as a box or polymeric sleeve that at least partially surrounds, contains, or contacts the primary packaging.

As used herein, “advertisement material” means a tangible medium of expression, which by itself or with the aid of a peripheral device, makes known the existence of, or proclaims the quality or advantages of, an associated consumer product.

As used herein, “consumer product aspect” includes a product attribute, a targeted benefit of the consumer product, and any other property associated with the consumer product.

As used herein, “attribute” means a quality or characteristic inherent in or ascribed to a particular consumer product.

As used herein, “targeted benefit” means an outcome that is believed achievable the majority of the time by using a particular consumer product in accordance with the product's directions of use.

As used herein, “removably affixed” means a first object can be removed from a second object to which the first object is affixed without a significant amount of destruction or distortion of either the component or the object, wherein the first object and/or second object remains essentially intact, and if desired, is useable for its initial function or any other use for providing visual stimulus. The first object may optionally be subsequently attached to the second object or to a third object.

As used herein, “foil laminate optical material” refers to a metal foil, typically aluminum foil, laminated to the surface of paper, card, board stock or other substrate or laminated to or between polymer films and optionally over printed, or a metallized polymer film laminated to a polymer, paper, card, board stock or other substrate surface and optionally over printed.

As used herein, “embossed foil micro-optic material” refers to a metal foil, typically aluminum foil, laminated to the surface of paper, card, board stock or other substrate, or laminated to or between polymer films, that is mechanically embossed to create a surface relief pattern and optionally over printed.

As used herein, “Fresnel reflector micro-optic material” refers to a polymer surface replication of a Fresnel lens or Fresnel reflector focusing surface that may be optionally metallized, optionally overprinted, and optionally laminated to a second substrate.

As used herein, “rainbow diffractive micro-optic material” refers to a polymer surface replication of a uniform holographic, diffraction grating, or diffractive micro-structure surface that may optionally be coated with a reflective material, laminated to a substrate, or over printed.

As used herein, “kinegram diffractive micro-optic material” refers to a polymer surface replication of a non-uniform patterned diffractive micro-structure surface that may optionally be coated with a reflective material, laminated to a substrate, or over printed.

As used herein, “cylindrical lens micro-optic material” refers to a multi-layer polymer construction incorporating a surface replication of a cylindrical lens array on the top surface of a transparent substrate and a linear pattern of interleaved images printed on the back surface of the substrate.

As used herein, “optical brightener” and “bleaching agent” include, but are not limited, to related materials disclosed in U.S. Pat. Nos. 5,789,368; 6,326,348; 6,583,096; and 6,887,838.

As used herein, “keratinous tissue” refers to keratin-containing layers disposed as the outermost protective covering of mammals which includes, but is not limited to, skin, hair, toenails, fingernails, cuticles, hooves, etc.

As used herein, the term “topical application” means to apply or spread beauty care compositions in accordance with the present invention onto the surface of the keratinous tissue.

As used herein, “dermatologically acceptable” means that the beauty care compositions or components described are suitable for use in contact with human keratinous tissue without undue toxicity, incompatibility, instability, allergic response, and the like.

As used herein, the term “safe and effective amount” means an amount of a compound or composition sufficient to significantly induce a positive benefit, as an example, a positive keratinous tissue appearance or feel benefit, including independently or in combination the benefits disclosed herein, but low enough to avoid serious side effects (i.e., to provide a reasonable benefit to risk ratio, within the scope of sound judgment of the skilled artisan).

As used herein, the term “post-inflammatory hyperpigmentation” refers to the changes in melanin content as a response to an inflammatory event (e.g., acne, scratch, insect sting or bite, sunburn, etc), especially in dark skin subjects.

As used herein, the term “hyperpigmentation” refers to an area of skin wherein the pigmentation is greater than that of an adjacent area of skin (e.g., a pigment spot, an age spot, and the like).

As used herein, the terms “desquamation, exfoliation, and/or turnover” mean the removal of the upper layers of the stratum corneum (comprising the horny layers).

As used herein, the terms “oily and/or shiny appearance” mean the glossy look mammalian skin tends to exhibit upon the excretion of oil, sebum, and/or sweat from the respective source gland.

As used herein, the term “sagging” means the laxity, slackness, or the like condition of skin that occurs as a result of loss of, damage to, alterations to, and/or abnormalities in dermal elastin.

As used herein, the term “smoothing” and “softening” means altering the surface of the keratinous tissue such that its tactile feel is improved.

As used herein, the term “sallowness” means the pale color, yellow color or the like condition of skin that occurs as a result of a loss of, damage to, alterations to, and/or abnormalities in skin components such that they become colored (e.g., yellow in color) due to processes such as protein glycation and accumulation of lipofuscin or in the decrease in peripheral blood flow that typically accompanies skin aging.

The present invention is directed to merchandising systems that include a consumer product, indicia and/or an image associated with the consumer product, and micro-optic technology for featuring at least a portion of the indicia/image. The micro-optic technology and the indicia or images can be associated with the consumer product itself, packaging for the consumer product, and/or advertisement materials pertaining to the consumer product.

Although the present invention is not limited to consumer products falling within specific categories, a representative, non-limiting list of product categories includes antiperspirants, baby care, colognes, commercial products (including wholesale, industrial, and commercial market analogs to consumer-oriented consumer products), cosmetics, deodorants, dish care, feminine protection, hair care, hair color, health care, household cleaners, incontinence care, laundry, oral care, paper products, personal cleansing, disposable absorbent articles, pet health and nutrition, prescription drugs, prestige fragrances, skin care, snacks and beverages, special fabric care, shaving and other hair growth management products, small appliances, devices and batteries. A variety of product forms may fall within each of these product categories. Exemplary product forms and brands are described on The Procter & Gamble Company's website www.pg.com, and the linked sites found thereon. It is to be understood that consumer products that are part of product categories other than those listed above are also contemplated by the present invention, and that alternative product forms and brands other than those disclosed on the above-identified website are also encompassed by the present invention.

Exemplary products within the laundry category include detergents (including powder, liquid, tablet, and other forms), bleach, conditioners, softeners, anti-static products, and refreshers (including liquid refreshers and dryer sheets). Exemplary products within the oral care category include dentifrice, floss, toothbrushes (including manual and powered forms), mouth rinses, gum care products, tooth whitening products, and other tooth care products. Exemplary feminine protection products include pads, tampons, interlabial products, and pantiliners. Exemplary baby care products include diapers, wipes, baby bibs, baby change and bed mats, and foaming bathroom hand soap. Exemplary health care products include laxatives, fiber supplements, oral and topical analgesics, gastro-intestinal treatment products, respiratory and cough/cold products, heat delivery products, and water purification products. Exemplary incontinence care products include diapers, pads, and liners. Baby care, incontinence care and feminine protection products may be marketed for purposes of managing urinary and/or fecal incontinence; absorbing or containing bodily wastes; toilet training; and/or protecting skin. Exemplary paper products include toilet tissues, paper towels, and facial tissues. Exemplary hair care products include shampoos, conditioners (including rinse-off and leave-in forms), and styling aids. Exemplary household care products includes sweeper products, floor cleaning products, wood floor cleaners, antibacterial floor cleaners, fabric and air refreshers, and vehicle washing products. Skin care products include, but are not limited to, body washes, facial cleansers, hand lotions, moisturizers, conditioners, astringents, exfoliation products, microdermabrasion and peel products, skin rejuvenation products, anti-aging products, masks, UV protection products, and skin care puffs, wipes, discs, clothes, sheets, implements and devices (with or without skin care compositions).

Indicia and/or images associated with the consumer product are included in the merchandising systems of the present invention. Exemplary indicia include brand names, trademarks, and non-trademarked text, manufacturer, distributor, and retailer names, and/or graphics. Other indicia may also be used with the merchandising systems of the present invention. Images can include, but are not limited to, illustrations or pictorial representations of the unpackaged consumer product (e.g., a potato crisp), the consumer product in use (e.g., a diaper being worn by an infant), instructions for the use of the consumer product, and applications of the product (e.g., a substrate to which the product is applied-skin, hair, clothes, furniture, etc.).

In one embodiment, the indicia and/or image relates to an attribute of the consumer product. The indicia and/or image may for example exhibit a pictorial representation of a source (or associated source) of a fragrance or flavor associated with a consumer product. For example, a hazelnut-flavored coffee product may contain an image of a hazelnut on its packaging or advertisement material, and a lavender-scented hair care product may contain an image of lavender on its packaging or advertisement. Consumers generally have a preference for a particular fragrance or flavor of a product when multiple options are available, and therefore, indicia or images that can communicate the different fragrances or flavors, can enable the consumer to conveniently locate their preferred product. The indicia and/or image can also exhibit text that describes one or more attributes of the consumer product. For example, the text may describe a product's feel, look, intensity, size, scent, or flavor. This type of indicia and/or image can provide visual imagery that communicates or conveys information to a prospective buyer to help them quickly and easily ascertain important aspects of the consumer product. Accordingly, indicia and/or images that relate to an attribute of a consumer product provide much more than mere dress for the consumer product and prospective buyers may choose or may need to rely on such to make an informed purchase decision.

In another embodiment, the indicia and/or image relates to a targeted benefit that is believed achievable by using the consumer product in accordance with the product's indicated use and directions for use. Many consumer products are targeted to change a substrate or environment, to which it is applied, from one condition to another condition; e.g., alter or improve the appearance and/or smell of a substrate or environment. The indicia or images associated with a hair care product may, for example, relate to cleanliness, vibrancy, shine, or color that is achievable by applying the hair care product to mammalian hair. The indicia or images associated with a skin care product may, for example, relate to improving the appearance of skin tone or texture. And the indicia or images associated with a detergent may, for example, relate to an improvement in both appearance and smell. As with indicia or images relating to a product attribute, those relating to a targeted benefit can communicate important product information to prospective buyers. Consumers may face dozens or hundreds of different product options, and thus, indicia or images related to a product's targeted benefit can help a consumer decide which product is best suited for their particular need(s).

The merchandising systems of the present invention include micro-optic technology/structures that are capable of featuring at least a portion of the indicia or images associated with a consumer product. “Featuring,” as used herein, means to highlight, accentuate the appearance of, bring attention to, or otherwise visibly distinguish at least a portion of the indicia or images from their surrounding. The featuring is intended to catch the eye of a prospective buyer (or product user post-purchase) and to help distinguish a particular product from competing products. A consumer can face an overwhelming number of product options when walking down the aisle of store, or when viewing a section of store shelving. The micro-optic effect or featuring accordingly is intended to draw the consumer towards the particular consumer product associated with merchandising systems of the present invention. After directing the prospective buyer's attention to the particular consumer product, the featuring or effect may also facilitate the viewing and/or understanding of the indicia or images. Furthermore, the micro-optic effect or featuring itself may have attributes that relate or are analogous to an attribute and/or a targeted benefit of the particular consumer product. Specific types of “featuring” will be discussed below in connection with technology that is capable of providing the same.

Micro-optic structures generally comprise one or more optical structures that manage the reflection and/or transmission of light impinging thereon. A representative, non-limiting list of optical structures/elements include lenses, reflectors, non-imaging collectors, prisms, waveguides, mirrors, gratings, structural interference filters, and photonic crystals. Other optical structures/elements known to one of ordinary skill in the area of micro-optic technology are encompassed herein. The optical structures/elements may be sized in the micron or nanometer range.

Formation of indicia or images may be viewing angle dependent or viewing angle independent depending on the type of micro-optic technology employed. Some micro-optic structures may be adapted to display different images or image portions to each of an observer's eyes to yield a stereoscopic image. Other micro-optic structures may be adapted to display the same image or image portion to both of an observer's eyes at a particular viewing angle, but different images or image portions at predetermined different viewing angles. And still other micro-optic structures may be adapted to produce 3-D or suspended (including “float” and/or “sink” appearances) indicia or images. In one embodiment, the micro-optic structure features an aspect of the indicia by displaying an image wherein the aspect appears to lie in a plane that differs from the apparent plane of at least one other aspect of the indicia. The multi-planar appearance of the indicia may be used to accentuate the appearance of an aspect of the indicia. In one embodiment the particular aspect may be made to appear in front of, or above, the plane of the remainder of the indicia. In another embodiment, the particular aspect may be made to appear beneath or behind the plane of other portions of the indicia. In still another embodiment, the particular aspect and other aspects of the indicia may be made to appear in three distinct planes, an upper, middle and lower plane of display. The particular aspect may be made to appear in the plane of the indicia while other aspects of the indicia are made to appear above or below that plane.

The following documents disclose micro-optic technology/structures useful in the present invention and methods for making the same: U.S. Pat. Nos. 5,359,454; 5,461,495; 5,475,533; 5,503,902; 5,568,313; 5,715,316; 6,288,842; and 6,870,681, and U.S. Published Patent Application Nos. 2003/0179364; 2003/0232179; 2004/0042753; 2004/0067360; and 2005/0180020. It is to be understood that other micro-optic technology/structures may equally be employed in the present invention.

The micro-optic technologies disclosed in the above-identified patent documents are adapted to create various effects of indicia or images that are positioned appropriately relative to the micro-optic technologies. For example, U.S. Pat. No. 5,475,533 (the “'533 patent”) and U.S. Published Patent Application No. 2003/0179364 (the “'364 application”) disclose micro-optic structures that are capable of directing reflected light in a specific field of view to intensify the brightness of an associated indicium or image, causing the indicium or image to appear, within the specific field of view, as though it were illuminated by a backlight. Conventional printing and imaging substrates, such as high whiteness papers, scatter light in all directions in a Lambertian distribution, wherein a majority of the light illuminating indicia or images is wasted, scattered away from a viewer. The micro-optic structures disclosed in the '533 patent and the '364 application include a plurality of reflective optical elements, each of which comprises a non-planar surface (curved in at least one dimension) that reflects light impinging on the reflective optical elements in a defined field of view (specific viewing angle). The geometry of the reflective optical elements controls scatter of the reflected light, and concentrates the reflected light into the defined field of view in which an associated indicium or image appears brighter or illuminated compared to its appearance outside the defined field of view.

U.S. Published Patent Application No. 2004/0042753 discloses micro-optic structures comprising optical waveguides. The optical waveguides are generally defined by at least two polymer layers which have different indices of refraction. In one embodiment, the optical waveguide includes optical elements that receive light illuminating the optical waveguide and then manipulate the received light so that it is concentrated in a defined area and reemitted from the optical waveguide to produce an intensified area of light reflection and/or transmission. Indicia or an image located proximate the reemitted light will appear illuminated or brighter relative to the area surrounding the same. In one embodiment the reemitted light may be directed to form a partial or complete perimeter or halo around the indicia or image.

U.S. Pat. No. 6,288,842 discloses a microlens sheeting material having a composite image that appears to be suspended above or below the sheeting. These suspended images can be referred to as floating images, and they can be located above or below the sheeting (either as two or three- dimensional images), or can be a three-dimensional image that appears above, in the plane of, and below the sheeting. The images can be in black and white or in color, and can appear to move with the observer. The floating image(s) can be observed by a viewer with the unaided eye.

U.S. Published Patent Application No. 2005/0180020 discloses a film material that utilizes a regular two-dimensional array of non-cylindrical lenses. There are a number of distinct visual effects that can be provided by the film material, which the application refers to as “Unison” for the material in general, or by the names “Unison Motion”, “Unison Deep”, “Unison SuperDeep”, “Unison Float”, “Unison SuperFloat”, “Unison Levitate”, “Unison Morph”, and “Unison 3-D” for Unison material presenting those respective effects. Unison Motion presents images that show orthoparallactic movement (OPM)-when the material is tilted, the images move in a direction of tilt that appears to be perpendicular to the direction anticipated by normal parallax. Unison Deep, and SuperDeep present images that appear to rest on a spatial plane that is visually deeper than the thickness of the material. Unison Float, and SuperFloat present images that appear to rest on a spatial plane that is a distance above the surface of the material; and Unison Levitate presents images that oscillate from Unison Deep (or SuperDeep) to Unison Float (or SuperFloat) as the material is rotated through a given angle (e.g. 90 degrees), then returning to Unison Deep (or SuperDeep) again as the material is further rotated by the same amount. Unison Morph presents synthetic images that change form, shape, or size as the material is rotated or viewed from different viewpoints. Unison 3-D presents images that show large scale three-dimensional structure, such as an image of a face.

U.S. Pat. No. 5,359,454 (the “'454 patent”) discloses an apparatus for producing thin-film autostereoscopic and dynamic images. This is accomplished through the use of a light control material comprised of a multi-layer optical system. In one embodiment of the disclosed in the '454 patent, the first layer of the optical system (generally referred to as the “outer optic”, i.e., the layer closest to the observer) consists of focusing elements. These elements may consist of refractive cylindrical lenses, diffractive optic lenses or mixed optic lenses. The second layer consists of light control optics (often referred to as the “inner optic”). This layer is designed to provide directional control of the light passing out through the outer optic to the observer. The inner optic consists of a pattern of bright zones disposed parallel to the axial direction of the outer optic lenses. Light absorbing or light dispersing zones (dark zones) separate the bright zones on the inner optic from each other.

In one embodiment micro-optic embodiments are in the form of flexible sheeting material that include a plurality of optical elements, such as, for example, lenses and reflectors. The flexible sheeting material may include a single layer or multiple layers. The flexible sheeting material may optionally be affixed to a substrate. Indicia or images may be printed directly on the flexible sheeting material, or may be printed on a separate sheeting material which is subsequently laminated (including affixed, attached or adhered) to the flexible sheeting material.

In accordance with the merchandising systems of the present invention, at least one of the consumer products, packaging for the consumer product, and advertisement material pertaining to the consumer product comprises the indicia and/or image and the micro-optic structure to feature the same. The combination of a micro-optic structure and indicia/image may be referred to herein as a “micro-optic-indicia system.” Thus, in one embodiment, a micro-optic—indicia system is incorporated directly with the consumer product itself. The micro-optic—indicia system may form at least a portion of the outer layer or surface of the consumer product, or be permanently affixed or removably affixed (e.g., peelable) to the product's outer layer or surface. For example, a micro-optic-indicia system may form at least a portion of the liquid impermeable backsheet of a baby diaper.

In a second embodiment, packaging for the consumer product comprises the indicia and/or image and the micro-optic structure. The packaging may be primary packaging, secondary packaging, and/or additional packaging. The type of packaging associated with the present invention is unlimited. The packaging can be made from a variety of materials, can be made in numerous configurations, and can be made with any manufacturing techniques known to the skilled artisan. Exemplary packaging embodiments include boxes, bags, pouches, paperboard cans, bottles, tottles, jars, thermoform blisters, clamshells, and combinations thereof. Other packaging embodiments are equally suitable. In accordance with this embodiment, a micro-optic—indicia system may form at least some of the packaging itself, or alternatively be separately manufactured and affixed to the packaging.

The micro-optic indicia system may be employed in conjunction with other visual elements such as metal foils, iridescent and fluorescent inks and other visual elements as are known in the art.

The micro-optic—indicia system may be included with or take the form of a label or other package element that can be affixed to the consumer product itself, advertisement material pertaining to the consumer product, and/or packaging of the consumer product. The label can be completely or partially affixed to packaging of the product after the packaging is formed or during its formation (e.g., in-mold labeling). The label can be removable (e.g., peelable), and in some embodiments can be reaffixed to the consumer product or its packaging, or affixed to another substrate. In some cases, it may be desirable that the removal step be done with little or no damage (e.g., no unintended distortion, tears, etc) to the label or micro-optic—indicia system; and/or, the consumer product, advertisement material or packaging to which it was previously affixed. Consumer products and or its packaging may contain more than one micro-optic—indicia system, and may also contain labels and other product information features that do not contain micro-optic—indicia systems.

In a third embodiment, advertisement materials and/or devices pertaining to the consumer product comprises the indicia and/or image and the micro-optic structure. Exemplary advertisement materials/devices include, but are not limited to, point-of-sale devices and/or materials, sample products and related information, coupons, mailers, periodical advertisement documents, product brochures, product inserts, product displays, shelf talkers, billboards, posters, buses, outdoor seating, and any other advertisement media available to prospective buyers. Advertisement materials/devices can be completely or partially affixed (permanently or removably) to consumer products or its packaging, or included within the consumer product packaging, for example. Disposing micro-optic—indicia systems within packaging provides an opportunity to communicate aspects of the consumer product as package components are opened or otherwise manipulated to allow access to the consumer product. Peelable labels or other micro-optic—indicia system elements may be affixed to advertisement materials/devices, so that a consumer can remove them, transport them, and/or affix them to a chosen substrate. Advertisement materials themselves may be made, at least in part, from micro-optic—indicia systems.

As noted above, indicia or images associated with the consumer product may relate to an attribute or targeted benefit of the consumer product, such that the indicia or images visually communicate important purchase-decision related information to prospective buyers. An additional level of visual imagery may be provided by the micro-optic technology and its effect(s). This additional level of visual imagery may also relate or be analogous to an attribute or targeted benefit of the consumer product. For example, micro-optic technology that is capable of managing light scatter such that reflected light is concentrated within a defined field of view to provide a zone of brightness, such as that disclosed in U.S. Pat. No. 5,475,533, and U.S. Published Patent Application Nos. 2003/0179364 and 2004/0042753, for example, can be employed with consumer products that are marketed for altering the appearance of a substrate to which it is applied, consumer products that employ or provide energy (e.g., batteries), or products with a sharp or defined edge (e.g., razors and blades).

In one embodiment the indicia comprises a first portion related to a first appearance of a substrate and also a second portion related to a second appearance of the substrate. In this embodiment, the first and second portions may be utilized to illustrate before and after appearances associated with the use of the consumer product.

Micro-optic technology that concentrates reflected light within a defined field of view can be employed to provide additional visual imagery to prospective buyers about a consumer product that is marketed to clean, brighten, whiten, lighten, refresh, condition, and/or rejuvenate a substrate or environment; or that is marketed to provide vibrancy, luminosity, and/or shine to a substrate. That is, the effect of the micro-optic technology is linked to a targeted benefit of the consumer product, such that the micro-optic technology effect itself can communicate purchase-decision related information to prospective buyers. Exemplary substrates include, but are not limited to, mammalian keratinous tissue (skin, hair, toe and finger nails), teeth, clothing, textiles, hard surfaces, architectural surfaces, furniture, appliance surfaces, flooring, home and personal decor, and vehicle surfaces. The indicia or images that are being featured by the micro-optic technology that manages reflected light within a defined field of view may or may not also relate to a targeted benefit of the consumer product. The indicia or images may be a brand name, trademark, or other non-trademarked text and/or graphics that do not necessarily communicate any of the above-identified benefits. Thus, the micro-optic effect can provide visual imagery related to an aspect of the corresponding consumer products, independent of the content of the featured indicium or image.

One merchandising system of the present invention includes a laundry care product that is marketed for cleaning, brightening, whitening, and/or refreshing clothes; indicia and/or an image associated with the laundry care product; and a micro-optic structure that is capable of managing reflected/transmitted light into a field of view, so that the indicia and/or image appears brighter or illuminated when viewed within the field of view versus when viewed outside the field of view.

Another merchandising system of the present invention includes an oral care product that is marketed for cleaning, brightening, whitening, and/or lightening one's teeth, and/or refreshing one's breath; indicia and/or an image associated with the oral care product; and a micro-optic structure that is capable of managing reflected light into a field of view, so that the indicia and/or image appears brighter or illuminated when viewed within the field of view versus when viewed outside the field of view.

Another merchandising system of the present invention includes a beauty care product that is marketed for changing the appearance of one's skin and/or hair; indicia and/or an image associated with the beauty care product; and a micro-optic structure that is capable of managing reflected light into a field of view, so that the indicia and/or image appears brighter or illuminated when viewed within the field of view versus when viewed outside the field of view. Exemplary beauty care products include those that are marketed for improving skin tone and/or texture, improving the appearance of fines lines and wrinkles, diminishing brown spots or discoloration, reducing yellow appearance of skin, reducing redness of skin, combating manifestations of aging, promoting defined or luminous skin, and promoting shine, vibrancy, or luminosity. “Defined” skin may refer to youthful looking skin that is virtually free from discolorations, fine lines, and wrinkles; beautiful from any distance and any angle. Defined skin is more luminous and/or virtually flawless. “Luminosity” may refer to the way skin interacts with light. Young skin can work like a mirror, reflecting light, and creating a glow. Over time, damage to skin can diminish its ability to reflect light. The beauty care products may comprise skin care materials, actives or other such agents that contribute towards achieving the targeted benefit of such products. For example, the beauty care product may contain a known skin whitening or lightening agent.

Yet another merchandising system of the present invention includes a consumer product comprising a sunscreen; indicia and/or an image associated with the consumer product; and a micro-optic structure that is capable of illuminating at least a portion of the indicia and/or image by managing light impinging on the micro-optic structure.

Micro-optic technology that is capable of producing a “floating” indicia or image, such as that disclosed in U.S. Pat. No. 6,288,842 and U.S. Published Patent Application No. 2005/0180020, can be employed in merchandising systems of the present invention to convey a related consumer product attribute or targeted benefit, such as, for example, softness, lightness, airiness, freshness, steaminess, foaminess (including foaming, lathering, formation of bubbles), and aromaticness. Here again, the micro-optic technology effect itself can communicate purchase-decision related information to prospective buyers. For example, the consumer product may be a paper product (e.g., paper towel, facial tissue, toilet tissue), a baby care product, or a feminine hygiene product, and the floating effect is employed to communicate softness, strength, absorbency, lightness, airiness, and/or freshness. The consumer product may be a laundry care product and the floating effect is employed to communicate airiness and/or freshness.

Micro-optic technology that is capable of producing a “sinking” indicia or image, such as that disclosed in U.S. Pat. No. 6,288,842 and U.S. Published Patent Application No. 2005/0180020, can also be employed in merchandising systems of the present invention to convey a related consumer product attribute or targeted benefit. For example, the consumer product may be a paper product, a baby care product, or a feminine hygiene product and the sinking effect is employed to communicate the product's ability to receive and/or retain bodily fluids/solids. The accompanying indicia and/or images may be, for example, in the form of a droplet or other pictorial representation of fluids, such as urine and menses.

The present invention is also directed to consumer products, packaging of consumer products, and or advertisement materials pertaining to the consumer products that comprise multiple (two or more) sensorial-evoking elements, wherein one of the sensorial-evoking elements includes a visual stimulus comprising micro-optic technology to feature at least a portion of indicia/images associated with the consumer product. The type of featuring or effect provided by the micro-optic technology can vary. The technology can produce, for example, autostereoscopic, dynamic, suspended (“float” and/or “sink”), and 3-D images. The additional sensorial-evoking element(s) may comprise an olfactory stimulus, an auditory stimulus, a tactile stimulus (including surface texture and thermal aspects), a visual stimulus, or a combination thereof. Exemplary, and non-limiting olfactory structures include scratch and sniff structures, adhesives having volatile oils impregnated therein and other suitable means for providing a scent. Exemplary and non-limiting auditory structures include textured surfaces adapted to reproduce a particular sound upon interaction with a shopper, recorded sounds replayed as requested and other suitable means. Exemplary and non-limiting tactile structures include structures that emulate or duplicate surface textures of the product or other materials to suggest or illustrate the effect of the products. Exemplary visual structures include additional applications of the micro-optic technology/structures previously disclosed, lenticular structures, printed structures and other suitable structures for producing a visual effect. Employing multiple sensorial-evoking elements is intended to provide a more complete emotive interaction with prospective buyers and users of the consumer product. It is to be understood that the secondary sensorial-evoking element can reinforce the same specific product aspect (e.g., a product attribute or targeted benefit), or it can be directed to a different product aspect.

The secondary sensorial-evoking elements can provide stimulus with or without action by a consumer. That is, it can be continually active, or in a ready state, or alternatively be activated (directly or indirectly) by the consumer; e.g., a secondary sensorial-evoking element can comprise “scratch and sniff” technologies and configurations, or can be electronically facilitated and activated by manipulation of an activation mechanism or via a sensor.

Sensorial-evoking elements that include indicia or images and micro-optic technology to feature the indicia or images can communicate information (e.g., attribute or targeted benefit) relating to the consumer product to prospective buyers via the content of the indicia/images and/or via the effect provided by the micro-optic technology, as discussed above. Accordingly, if a second sensorial-evoking element also comprises indicia or images, their combination can potentially produce four levels of product-related information, even in the absence of text (where the indicia or images do not include text).

The following are examples of consumer products employing multiple sensorial-evoking elements on the product itself, its packaging, and/or advertisement material pertaining to the consumer product. A first exemplary embodiment includes an antiperspirant/deodorant product having an image of a surfer on its packaging or advertisement material that is featured by micro-optic technology, combined with 1) an olfactory-related sensorial element that produces a scent of suntan lotion; 2) an auditory-related sensorial element that produces sounds of surf; and/or 3) a tactile-related sensorial element that has the feel of a surfboard or a wet feel. A second exemplary embodiment includes a beauty care product having an image of a woman's face on its packaging or advertisement material that is featured by micro-optic technology, combined with 1) an auditory-related sensorial element that produces soft music; and/or 2) a tactile-related sensorial element that comprises a velvety or satiny feeling surface. A third exemplary embodiment includes a green-onion flavored snack item having an image of green onions on its packaging or advertisement material that is featured by micro-optic technology, combined with an olfactory-related sensorial element that can produce an onion scent. A fourth exemplary embodiment includes a coffee product having an image of a vanilla bean on its packaging or advertisement material that is featured by micro-optic technology, combined with an olfactory-related sensorial element that can produce a vanilla scent. Alternative embodiments are contemplated by the present invention, and claims reciting multiple sensorial-evoking elements are not limited to the exemplary embodiments described above.

The present invention is also directed to methods of merchandising a consumer product. A first exemplary method comprises the following steps: a) locating a first plurality of the consumer products belonging to a product category in a first location; 2) locating a second plurality of products, which are different from the first plurality of consumer products but belong to the same product category, in a second location that can be concurrently viewed with the first location; 3) displaying packaging and/or advertisement material pertaining to the plurality of consumer products proximate the first location, wherein the packaging and/or advertisement material comprises an image and a micro-optic structure; and 4) exposing the micro-optic structure to an illumination source whereby the image is featured, at least in part, by light reflecting from the micro-optic structure so that a consumer is capable of distinguishing the plurality of consumer products from the second plurality of products.

A second exemplary method includes communicating a textual (oral and/or written) communication to a prospective buyer, and communicating a non-textual visual communication to the prospective buyer, wherein both of the communications are related to brightness, luminosity, whitening, and/or lightening. The non-textual visual communication may be accomplished by employing micro-optic technology and indicia/images that are featured by the micro-optic technology, for example. This method may be used, for example, to merchandise skin care products that comprise lightening and/or whitening agents, such as, for example, hydroqunone, arbutin, sugar amines, kojic acid, mulberry extract, licorice extract, hexamidine, n-acyl amino acid compounds, and vitamin C or a derivative thereof.

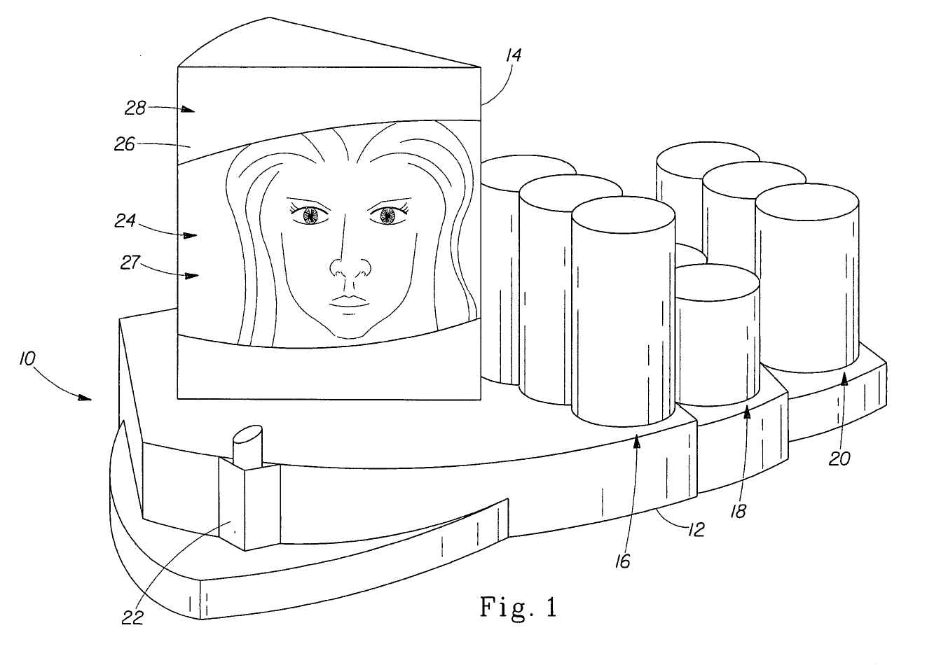

A third exemplary method comprises the steps of offering a consumer product for sale, and displaying a point-of-sale device associated with the consumer product. The point-of-sale device includes an image comprising at least a portion of a human face that appears illuminated relative to its surrounding. The point-of-sale device can have many forms including, but not limited to, a product display that is affixed to store shelving and/or other display structures, resting on a store shelf, or placed on the floor proximate shelving containing additional associated consumer products or at the end of an aisle, for example; a shelf-talker; an emblem or other structure affixed to the floor; a coupon booklet; and a product information document, booklet, or guide placed proximate the associated consumer product. With reference to FIG. 1, an exemplary point-of-sale device in the form of a display 10 is shown. Display 10 includes a base 12, an upwardly extending member 14, three rows 16, 18, 20 of beauty care products supported by base 12, and a test or sample beauty care product 22 that is also supported by base 12. Base 12 can be made from a variety of materials and by a variety of manufacturing methods known by the skilled artisan. Base materials include cellulosic-based materials, such as, for example, cardboard and corrugated board stock; as well as, polymeric materials, such as, for example, polyethylene or polypropylene. Bases that are made at least in part by polymeric materials may be thermoformed or injection molded, for example. Base 12 can be placed (as shown or with additional elements) on a store shelf, be affixed to a store shelf, or be placed in the aisle of a store, for example.

Upwardly extending member 14 includes an image 24 of a human face on a surface 26 that is positioned at an angle relative to base 12. The beauty care products included in rows 16, 18 and 20 may be skin care products that are marketed to improve the appearance of skin. For example, the beauty care products may be marketed for one or more of the following: improving the appearance of fine lines or wrinkles, improving skin tone, improving skin texture, diminishing brown spots or other discoloration, reducing yellow appearance of skin, reducing redness of skin, combating manifestations of aging and/or environmental factors.

At least some of the above-listed benefits may be characterized as achieving a highly defined or luminous skin appearance. In this context, image 24 has a bright or illuminated appearance. A number of different techniques can be employed to provide a bright or illuminated appearance to image 24. For example, micro-optic technology that is capable of managing reflected light within a field of view (i.e., control scatter and concentrate reflected light) may be employed. When an observer views image 24 within the field of view, the image appears bright or illuminated via the concentration of reflected light. U.S. Pat. No. 5,475,533 and U.S. Published Patent Application No. 2003/0179364 describe examples of such technology and methods for making the same. The human face included in image 24 can be printed or otherwise encoded in/onto micro-optic technology sheeting, or be printed on a separate substrate that is positioned proximate micro-optic sheeting. The above patent documents illustrate various configurations and methods of associating indicia/images with micro-optic structures.

Other techniques for making image 24 appear bright or illuminated relative to its surrounding include employing highly reflective (e.g., foils or laminations including foils) or high gloss substrates on which the human face is imprinted. Contrasting materials may be employed in region 27 and region 28, whereby region 27 has a lighter/brighter appearance. Furthermore, a dedicated illumination source may be employed with the display; for example, a light may be placed within or underneath upwardly extending member 14 such that image 24 appears to be backlit. A dedicated illumination source may also be positioned within a close distance (e.g., within 2 meters) of image 24 and directed toward the image. The dedicated illumination source may illuminate the image with a higher lux value than would otherwise be available by non-dedicated environmental lighting.

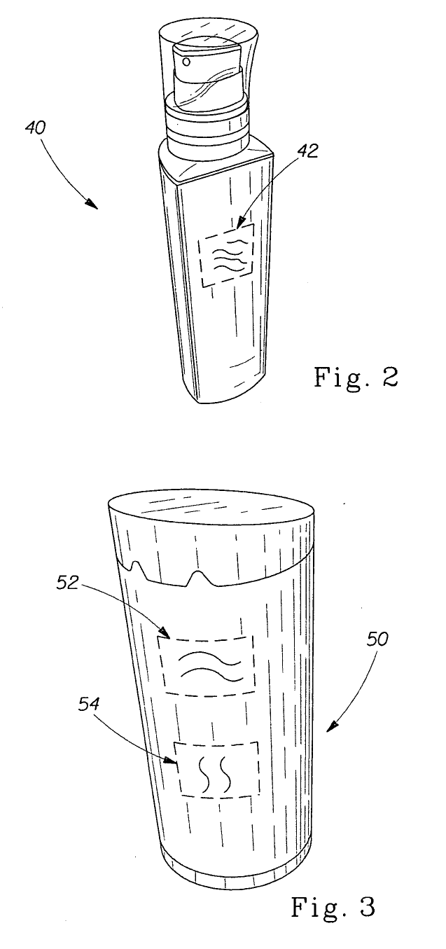

The beauty care products included in rows 16, 18, and 20 may be the same or may be different from one another. FIGS. 2 and 3 show an example of a packaged beauty care product that could be used with display 10. The beauty care product includes a primary packaging container 40 and a secondary packaging container 50. Primary packaging container 40 is configured to be received within secondary packaging container 50. Primary packaging container 40 may or may not be visible depending on the features of secondary packaging container 50.

Primary packaging container 40 is shown with a visual sensorial-evoking element 42 that includes an image and micro-optic technology to feature the same. Secondary packaging container 50 is shown with a first sensorial-evoking element 52 and a second sensorial-evoking element 54. First sensorial-evoking element 52 comprises indicia and micro-optic technology for visually featuring the indicia. Second sensorial-evoking element 54 comprises an olfactory-related stimulus that is capable of producing a fragrance. It is to be understood that the sensorial-evoking elements 52, 54 can be different from those described herein. Each of the elements can comprise visual, auditory, olfactory, and tactile stimuli. The sensorial-evoking elements can be similar or different.

Exemplary beauty care products may include optional ingredients or components that are suitable for use in contact with human keratinous tissue without undue toxicity, incompatibility, instability, allergic response, and the like within the scope of sound judgment. The CTFA Cosmetic Ingredient Handbook, Second Edition (1992) describes a wide variety of nonlimiting cosmetic and pharmaceutical ingredients commonly used in the beauty care industry, which are suitable for use in consumer products of the present invention. Examples of these ingredient classes include: abrasives, absorbents, aesthetic components such as fragrances, pigments, colorings/colorants, essential oils, skin sensates, astringents, etc. (e.g., clove oil, menthol, camphor, eucalyptus oil, eugenol, menthyl lactate, witch hazel distillate), anti-acne agents, anti-caking agents, antifoaming agents, antimicrobial agents (e.g., iodopropyl butylcarbamate), antioxidants, binders, biological additives, buffering agents, bulking agents, chelating agents, chemical additives, colorants, cosmetic astringents, cosmetic biocides, denaturants, drug astringents, external analgesics, film formers or materials, e.g., polymers, for aiding the film-forming properties and substantivity of the composition (e.g., copolymer of eicosene and vinyl pyrrolidone), opacifying agents, pH adjusters, propellants, reducing agents, sequestrants, skin bleaching and lightening agents, skin-conditioning agents, skin soothing and/or healing agents and derivatives, skin treating agents, thickeners, and vitamins and derivatives thereof.

Beauty care products associated with the present invention may also be useful in inhibiting hair growth, reducing shaving frequency, improving ease of shaving, decreasing shaving frequency, making hair softer and/or finer, making hair less noticeable, slowing the re-growth of hair, reducing erythema and/or irritation to skin, making skin smoother and/or silkier, and improving the hair removal process.

Exemplary beauty care products may also be in the form of cosmetics. Suitable cosmetic forms include, but are not limited to, foundations, lipsticks, rouges, mascaras, and the like.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A merchandising system, comprising:
a consumer product; and
at least one of the consumer product, packaging for the consumer product, and advertisement material pertaining to the consumer product comprising:
a) indicia and/or an image that relates or is analogous to an attribute and/or targeted benefit of the consumer product; and
b) an optical waveguide for illuminating at least a portion of the indicia and/or image.

2. The system of claim 1, wherein the optical waveguide is defined by a multi-layer polymeric film comprising a first polymer layer having an index of refraction that is higher than that of a second polymer layer.

3. The system of claim 1, wherein the optical waveguide is defined by a multi-layer polymeric film comprising:
a) a first planar polymer layer having an index of refraction that is higher than that of a second planar polymer layer; and
b) at least one optical element;
wherein light projected into the first planar polymer layer in a direction substantially parallel to the plane of the first planar polymer layer is guided through the first planar polymer layer by internal reflection, and wherein the at least one optical element is capable of altering a wavefront form or energy distribution of the light.

4. The system of claim 3, wherein the optical waveguide is sufficiently flexible to assume a non-planar configuration when affixed to the at least one of the consumer product, packaging for the consumer product, and advertisement material pertaining to the consumer product.

5. The system of claim 1, wherein the optical waveguide comprises a first polymer layer having at least one optical element formed therein for operating on light in a predetermined manner, the first polymer layer having at least two sides and a second polymer layer having at least two sides wherein one of the at least two sides of the first polymer layer is disposed adjacent to one of the at least two sides of the second polymer layer, the first polymer layer having a first index of refraction, the second polymer layer having a second index of refraction, the first index of refraction being higher than the second index of refraction, wherein light projected into the first polymer layer in a direction substantially parallel to the first and second sides of the first polymer layer will be guided through the first polymer layer by internal reflection.

6. The system of claim 1, wherein the indicia and/or image comprises a photograph or illustration of mammalian keratinous tissue.

7. The system of claim 1, wherein the indicia and/or image comprises a photograph or illustration of at least a portion of a human face.

8. The system of claim 1, wherein the consumer product is marketed for changing the appearance and/or condition of a substrate or environment to which it is applied.

9. The system of claim 8, wherein the substrate is selected from the group consisting of mammalian keratinous tissue, clothing, textiles, hard surfaces, architectural surfaces, furniture, appliances, vehicles, personal and/or home decor and accessories, and teeth.

10. The system of claim 8, wherein the consumer product is marketed for at least one of: cleaning the substrate, brightening the substrate, whitening the substrate and lightening the substrate.

11. The system of claim 1, wherein the consumer product is a beauty care product.

12. The system of claim 11, wherein the beauty care product is marketed for one or more of the following: improving the appearance of fine lines or wrinkles, diminishing discoloration, reducing yellow appearance of skin, reducing redness of skin, improving skin texture, improving skin tone,combating manifestations of aging, and promoting defined or luminous skin appearance.

13. The system of claim 1, wherein the indicia and/or image and the micro-optic structure are included in a label that is associated with the at least one of the consumer product, packaging for the consumer product, and advertisement material pertaining to the consumer product.

14. The system of claim 13, wherein the label is removably affixed to the at least one of the consumer product, packaging for the consumer product, and advertisement material pertaining to the consumer product.

15. The system of claim 14, wherein the removably affixed label can be affixed to a substrate after it is removed from the at least one of the consumer product, packaging for the consumer product, and advertisement material pertaining to the consumer product.

16. The system of claim 1, wherein the consumer product comprises a skin care active.

17. The system of claim 16, wherein the skin care active is selected from the group consisting of hydroquinone, arbutin, sugar amines, kojic acid, mulberry extract, licorice extract, hexamidine, n-acyl amino acid compounds, vitamin C or a derivative thereof, vitamin B3 or a derivative thereof, panthenol, vitamin E acetate, n-acetyl glucosamine, ascorbyl glucoside, retinyl propionate, organic sunscreens, metal oxide sunscreens, glycerol, petrolatum, caffeine, salicylic acid, vitamin B6, glycosyl hesperidin, phytosterol, cetyl pyridinium chloride, thiotaine, carnosine, hexanediol, tetrahydrocurcumin, peptide, dehydroacetic acid, green tea extract, and zinc pyrthione.

18. The system of claim 1, wherein the consumer product comprises an exfoliation agent, an optical brightner, a bleaching agent, an anti-oxidant/radical scavenger, an anti-inflammatory agent, an anti-microbial agent, an anti-acne agent, an anti-dandruff agent, a tanning agent, a UV protection agent, and/or an anti-cellulite agent.

19. The system of claim 1, wherein advertisement material pertaining to the consumer product comprises the indicia and/or image and the micro-optic structure, and wherein the advertisement material is selected from the group consisting of point-of-sale devices and/or materials, coupons, mailers, periodical advertisement documents, product brochures, product inserts, product displays, shelf talkers, billboards, posters, buses, outdoor seating, and combinations thereof.

20. The system of claim 1, wherein consumer product is selected from the group consisting of dentifrice, floss, toothbrushes, mouth rinses, gum care, tooth whitening products, detergents, fabric conditioners, dish care products, household cleaners, bleach, vehicle care, fabric and home cleaning implements, architectural surface treatment products, pet care, mammalian wipes, and toweling.
